(19) United States
(12) Patent Application Publication
(10) Pub. No.: US 2026/0300090 A1
(43) Pub. Date: Oct. 1, 2026

(54) CONFIGURABLE DATA BUS INVERSION OPERATION

(71) Applicant: Micron Technology, Inc., Boise, ID (US)

(72) Inventors: Aaron P. BOEHM, Boise, ID (US); Steffen BUCH, Taufkirchen (DE)

(21) Appl. No.: 19/565,031

(22) Filed: Mar. 12, 2026

Related U.S. Application Data
(60) Provisional application No. 63/778,089, filed on Mar. 26, 2025.

(51) Int. Cl. G06F 11/10

(52) U.S. Cl. CPC G06F 11/1048; G06F 11/1004

(57) ABSTRACT

In some implementations, a memory apparatus may obtain a data bus inversion (DBI) configuration indicating a first quantity of DBI bits to be used for a DBI operation. The memory apparatus may obtain a first data packet. The memory apparatus may obtain feature information that includes one or more first DBI bits of a second quantity, wherein the second quantity is based on the first quantity of DBI bits, and wherein the feature information includes a third quantity of bits for one or more memory features. The memory apparatus may process the first data packet based on the feature information.

### CROSS-REFERENCE TO RELATED APPLICATION

This Patent Application claims priority to U.S. Provisional Patent Application No. 63/778,089, filed on Mar. 26, 2025, entitled “CONFIGURABLE DATA BUS INVERSION OPERATION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a configurable data bus inversion operation.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of configurable data bus inversion operation.

FIG. 2 shows an example of a data packet that supports signaling for various memory features.

FIGS. 3A-3B are diagrams of an example of configurable data bus inversion operation.

FIG. 4 is a diagram of an example of a serial transport mechanism for a configurable data bus inversion operation.

FIG. 5 is a diagram of an example of a parallel transport mechanism for a configurable data bus inversion operation.

FIG. 6 is a flowchart of an example method associated with configurable data bus inversion operation.

### DETAILED DESCRIPTION

In some examples, the efficiency and performance of a memory system may be dictated by the constraints and/or capabilities of hardware components, such as the quantity of pins in the memory system. As memory operations and memory system architecture evolves, a limitation on high-speed data transmission or enhanced memory operations may be a quantity of available pins in the memory system. In some examples, a memory system may include multi-functional pins. A multi-functional pin may be a pin via which multiple functions or operations are performed. This may reduce the total quantity pins used for various memory operations. However, the memory system may be unable to perform shared functions or operations for a given multi-functional pin at the same time (e.g., as the multi-functional pin can only be used for a single function or operation at a given time).

In some examples, information for some memory operations may be transmitted within a data packet. This may reduce the quantity of pins associated with transmitting the information for some memory operations or features because the information can be transmitted via the pin(s) used to transmit the data packet, thereby alleviating the constraint of the quantity of available pins. However, amount of information for memory operations or features that can be transmitted in the data packet may be limited by an allowable size of the data packet. In some examples, some memory operations or features may share the same bit field within a data packet due to the constrained size of the data packet. As a result, a memory system may be unable to transmit information for multiple memory operations or features that are associated with the same bit field within a data packet. As a result, the memory system may be unable to perform simultaneous operation of those memory operations or features, in a similar manner as the multi-functional pin approach. As an example, a data bus inversion (DBI) operation may sometimes be allocated to a multi-functional pin or bit field that is shared with other memory operations or features, such as a parity feature or an error correction feature (e.g., a link error correction code (ECC) feature, an error detection code feature, or a cyclic redundancy check feature), among other examples.

A memory system may perform memory features or operations (e.g., that share multi-function pins or bit fields within a data packet) to improve system performance, improve reliability of data stored by the memory system, reduce power consumption of the memory system, and/or improve signal integrity, among other examples. “Feature” and “function” may be used interchangeably herein. In some examples, a memory system may perform one memory operation at the cost of foregoing another memory operation because both memory operations share the same multi-functional pin or bit field. For example, if a host system configures a given feature as being enabled, another feature (e.g., that shares a multi-functional pin or bit field with the given feature) may be automatically disabled. As an example, the memory system may not perform a DBI operation because the memory system is performing a parity function or an error correction function. Such trade-offs between the benefits of memory operations or features that share multi-function pins or bit fields within a data packet reduces the efficiency and performance of memory systems.

Some implementations described herein enable a configurable memory operation. For example, some implementations may enable a configurable DBI operation. In other examples, the configurable memory operation may be another memory operation that is associated with a multi-functional pin or data field that is shared among multiple memory operations or features. As an example, a memory apparatus may obtain a DBI configuration from a host system that indicates a quantity of DBI bits to be used for a DBI operation. The memory apparatus may obtain a data packet and one or more DBI bits from the host system. The quantity of the one or more DBI bits may be the quantity of DBI bits indicated by the DBI configuration. The memory apparatus may process the data packet based on the received DBI bits and the indicated quantity of DBI bits. For example, the data packet may be partitioned into DBI data blocks associated with respective DBI bits (e.g., where the quantity of DBI data blocks is based on the quantity of DBI bits indicated by the DBI configuration). The memory apparatus may process each DBI data block based on an associated DBI bit from the one or more DBI bits. Additionally, the one or more DBI bits may be included in a bit field of the data packet. The bit field may include bits for other memory operations or features (e.g., where the quantity of bits for the other memory operations or features is based on a size of the bit field and the configured quantity of DBI bits).

In some other implementations, the memory apparatus may obtain a data packet via a first pin and the one or more DBI bits via a second pin. In such examples, the second pin may be a multi-functional pin. The DBI configuration may indicate a quantity of DBI bits to be transmitted via the second pin. For example, over a given time window, a host system can configure the memory apparatus to obtain the given quantity of DBI bits via the second pin. During the time window, the host system may provide, and the memory apparatus may obtain, one or more other bits via the second pin. The one or more other bits may indicate information for one or more other memory operations or features.

As a result, the host system may configure a variable quantity of bits to be used for different memory operations or features (e.g., that share a multi-functional pin or a bit field in a data block). This enables a trade-off between the quantity of bits dedicated to different memory operations or features, such as between a DBI operation and a parity operation or an error correction operation. In this way, the host system may configure the memory apparatus with memory feature performance (e.g., a configurable quantity of bits used for a given memory feature), which may enable an optimized balance between available resources (e.g., bits that can be transmitted in a given bit field or via a given pin) and system performance that can be adapted based on different factors, such as system requirements, current operating conditions, one or more user preferences, application needs, power consumption constraints, and/or data integrity requirements, among other examples. The adaptability of the configuration facilitates efficient management of pin and bit field limitations in memory systems, contributing to improved signal integrity and reduced power consumption during operation by enabling the memory system to perform multiple functions that are shared between a single pin or a single bit field. By enabling the host system to configure a quantity of bits used for a given memory operation or feature, the host system can tailor the trade-off between DBI coverage and diagnostic coverage of other functions (such as link ECC), to an overall reliability and performance of the system. Furthermore, the host system can dynamically update the configuration for the memory apparatus based on operational changes, resulting in a reduction in power usage and an increase in data transmission efficiency for the memory apparatus. In this way, the memory apparatus may obtain information for multiple memory operations or features (such as a DBI operation and an ECC operation) via a given pin or a given bit field in a data block. This enables the memory apparatus to perform the multiple memory operations or features, thereby improving system performance, improving reliability of data stored by the memory apparatus, reducing power consumption of the memory apparatus, and/or improve signal integrity, among other examples.

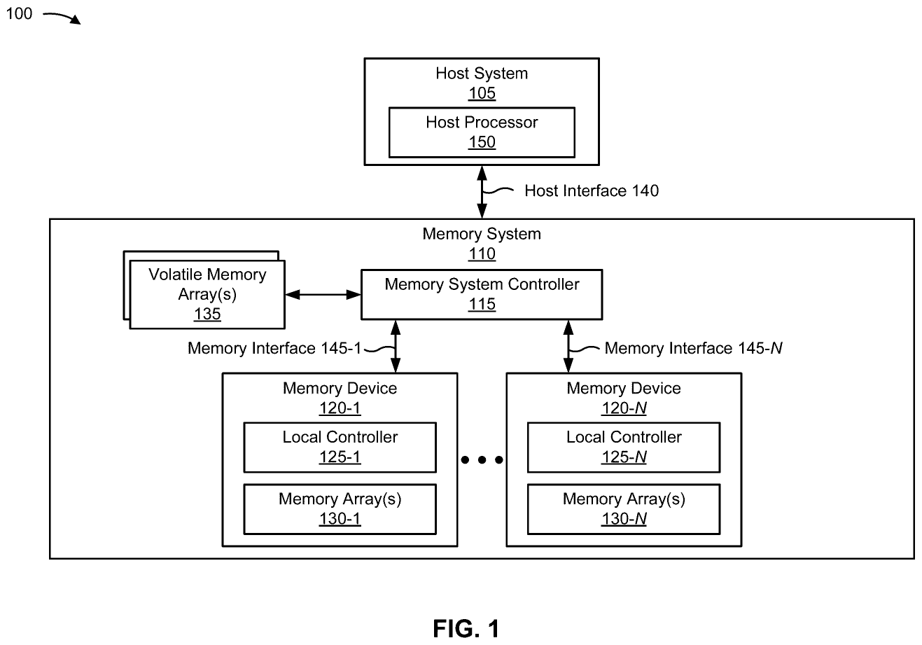

FIG. 1 is a diagram illustrating an example system 100 capable of configurable data bus inversion operation. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface. In some examples, the host interface 140 may include one or more buses, such as a control/address (C/A) bus and a data (DQ) bus. The system 100 may use the C/A bus to communicate command signals and/or address information between the host system 105 and the memory system 110. The system 100 may use the DQ bus to transmit data, including write data, read data, and/or system metadata associated with the data.

The host interface 140 may include one or more pins. A pin may be a physical connectors that facilitate the transfer of data, control signals, and power between the host system 105 and the memory system 110. A pin may enable communication and coordination of operations between the host system 105 and the memory system 110. Different types of pins may include data pins (e.g., DQ pins), address pins (e.g., C/A pins), control pins, power pins, clock pins, and/or input/output (I/O) pins, among other examples. Data pins may be used to transfer data between the host system 105 and the memory system 110. A data pin may carry the actual data being read from or written to the memory. For example, in a DDR memory interface, data pins transfer data on both the rising and falling edges of the clock signal, effectively doubling the data transfer rate. Address pins may carry the address information that specifies the location in the memory where data is to be read from or written to. Control pins carry signals that manage the operations of the memory system 110, such as read/write commands, chip select, and/or clock signals, among other examples. Power pins supply the necessary voltage to the memory system 110, while ground pins provide a reference voltage level. For example, voltage at the drain (VDD) pins supply the main operating voltage, and voltage at the source (VSS) pins are connected to ground. Clock pins provide the timing signals that synchronize data transfers between the host system 105 and the memory system 110. A clock pin in a synchronous memory interface may ensure that data is transferred at precise intervals.

I/O pins may be versatile connectors that can function as either inputs or outputs depending on the operation being performed. I/O pins enable bidirectional communication between the host system 105 and the memory system 110. I/O pins can switch between input mode (receiving data) and output mode (sending data) based on the control signals provided by the host system 105. For example, during a write operation, I/O pins receive data from the host system 105 to be stored in the memory system 110. During a read operation, I/O pins send data from the memory system 110 to the host system 105. The mode of I/O pins (input or output) may be controlled by specific control signals or configuration registers in the memory system 110.

A multi-functional pin may be connector in the host interface 140 that can perform multiple roles or functions depending on the current operation or configuration. A multi-functional pin can be dynamically assigned to handle different tasks such as data transfer, control signaling, and/or power management, among other examples, thereby reducing the total number of pins required in the system 100. For example, a multi-functional pin in the host interface 140 might be used for both DBI operations and error correction functions, with the specific function being determined by the current needs or configuration settings of the system 100. This flexibility helps optimize the use of available pin resources and can improve overall system efficiency and performance.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The system 100 may operate according to a protocol that supports a write burst mode in which the host system 105 communicates a data packet to the memory system 110. The memory system 110 may store a payload (e.g., user data) included in the data packet to one or more memory devices 120 of the memory system 110. The data packet may further include control information associated with the payload, such as metadata generated by the host system 105 (sometimes referred to as system metadata), and/or communication control information associated with communicating the data packet. Such communication control information may be used to improve the reliability of communicating the data packet. For example, the communication control information may include link parity information. Link parity information may be parity information (e.g., one or more ECCs) and/or one or more error detection codes (EDCs) used to detect and/or correct one or more errors in the data packet that occur during communication (e.g., transmission and/or reception) of the data packet between the host system 105 and the memory system 110.

For example, to communicate a data packet from the host system 105 to the memory system 110, the host system 105 may generate link parity information using the payload and/or system metadata associated with the payload. The host system 105 may provide the data packet, which may include the payload, the system metadata, and the link parity information, to the memory system 110. After obtaining the data packet, the memory system 110 may detect and/or correct one or more errors in the payload and the system metadata using the link parity information. The memory system 110 may then store the payload and system metadata to the one or more memory devices 120.

In some cases, the communication control information may include an inversion configuration associated with the payload and/or the system metadata. An inversion configuration may include one or more bits, where each bit indicates whether a respective portion of the payload is to be inverted as part of a DBI operation. The host system 105 and/or the memory system 110 may encode a payload according to an inversion configuration to improve the integrity and/or efficiency of communicating the payload. For example, the inversion configuration may be selected to mitigate the duration that pins of the data bus (e.g., pins of the host interface 140) are driven to a high voltage state (e.g., by mitigating the quantity of logical “1s” in the payload), which may reduce power consumption. Additionally, or alternatively, the inversion configuration may be selected to mitigate the variance in the payload, such as by reducing the quantity of transitions between a high voltage state and a low voltage state of pins of the data bus, which may reduce noise or other interference. As another example, the link parity information and the inversion configuration (e.g., one or more DBI bits) may be communicated via a multi-functional pin associated with the host interface 140.

However, some communication protocols may not allow the system 100 to include both link parity information and an inversion configuration (e.g., one or more DBI bits) in a data packet. Similarly, some communication protocols may not allow the system 100 to communicate both link parity information and an inversion configuration (e.g., one or more DBI bits) via the same multi-functional pin over a given time window. For example, some communication protocols may provision a fixed quantity of bits of the data packet to be used for communication control information. Such a fixed quantity of bits may allow including the link parity information or the inversion configuration, but not both, thus increasing power consumption, reducing signal integrity, and/or increasing the likelihood of errors occurring during communication of the data packet. Similarly, some communication protocols may enable the system 100 to operate in a state in which the link parity information or the inversion configuration, but not both, can be communicated via a given multi-functional pin.

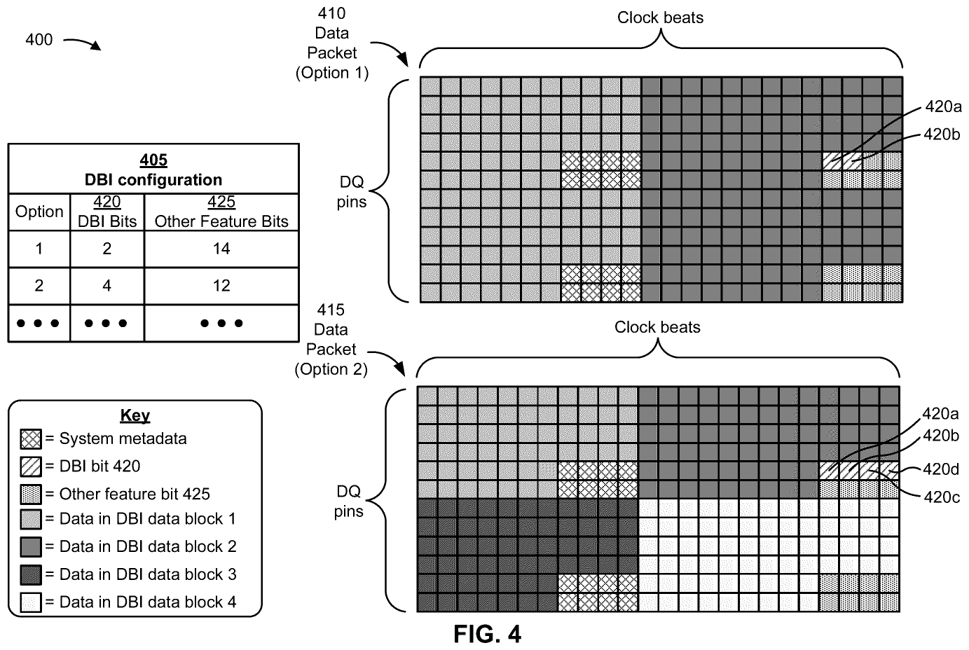

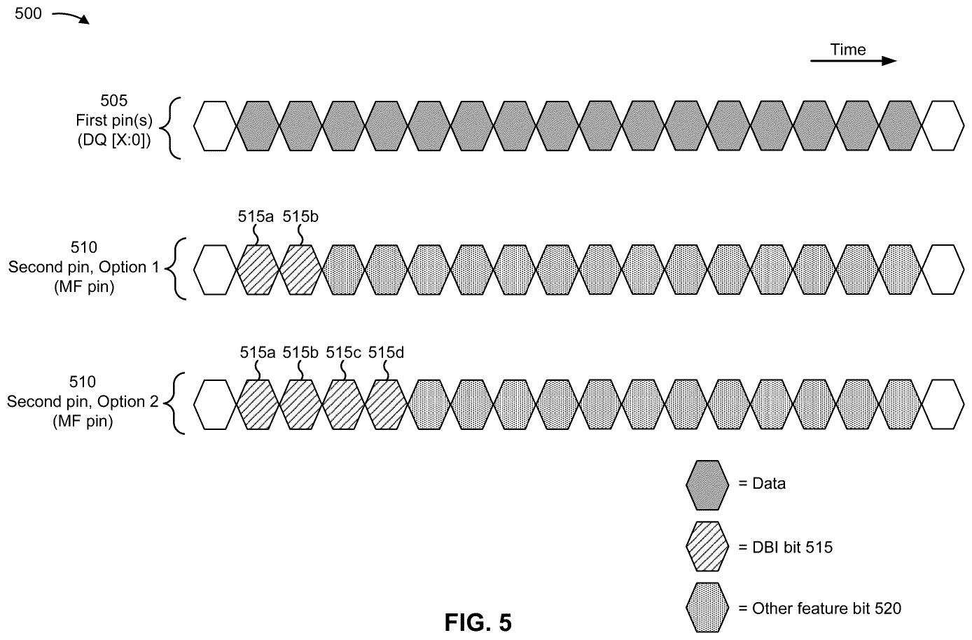

As described in more detail herein, the host system 105 may provide the memory system 110 with a configurable amount of information to be communicated for a given memory operation or feature, where the given memory operation or feature is associated with a bit field or multi-functional pin that is associated with (e.g., that is shared between) multiple memory operations or features. For example, the host system 105 may provide the memory system 110 with a configurable amount of information to be communicated for a DBI operation. This enables the host system 105 to balance a trade-off between the multiple memory operations or features, such as between a DBI operation and a link parity operation. Additionally, this enables the memory system 110 to perform the multiple memory operations or features using information obtained via a given bit field (e.g., as depicted and described in more detail in connection with FIG. 4) or a given multi-functional pin (e.g., as depicted and described in more detail in connection with FIG. 5).

In some implementations, one or more systems, devices, apparatuses, components, and/or controllers of FIG. 1 may be configured to obtain, from a host system, a DBI configuration indicating a first quantity of DBI bits to be used for a DBI operation; obtain, from the host system, a data packet; obtain, from the host system, one or more DBI bits of a second quantity, wherein the second quantity is equal to the first quantity of DBI bits; and process the data packet based on the one or more DBI bits and based on the first quantity of DBI bits.

In some implementations, one or more systems, devices, apparatuses, components, and/or controllers of FIG. 1 may be configured to obtain, from a host system, a DBI configuration indicating a first quantity of DBI bits to be used for a DBI operation; obtain, from the host system, a first data packet; obtain feature information that includes one or more first DBI bits of a second quantity, wherein the second quantity is based on the first quantity of DBI bits, and wherein the feature information includes a third quantity of bits for one or more memory features; and process the first data packet based on the feature information.

In some implementations, one or more systems, devices, apparatuses, components, and/or controllers of FIG. 1 may be configured to a host system configured to: program a DBI configuration for a memory apparatus, wherein the DBI configuration indicates a quantity of DBI bits to be used for a DBI operation; provide, to the memory apparatus, a data packet; and provide, to the memory apparatus, one or more DBI bits for the DBI operation and for the data packet, wherein the one or more DBI bits have the quantity of DBI bits.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

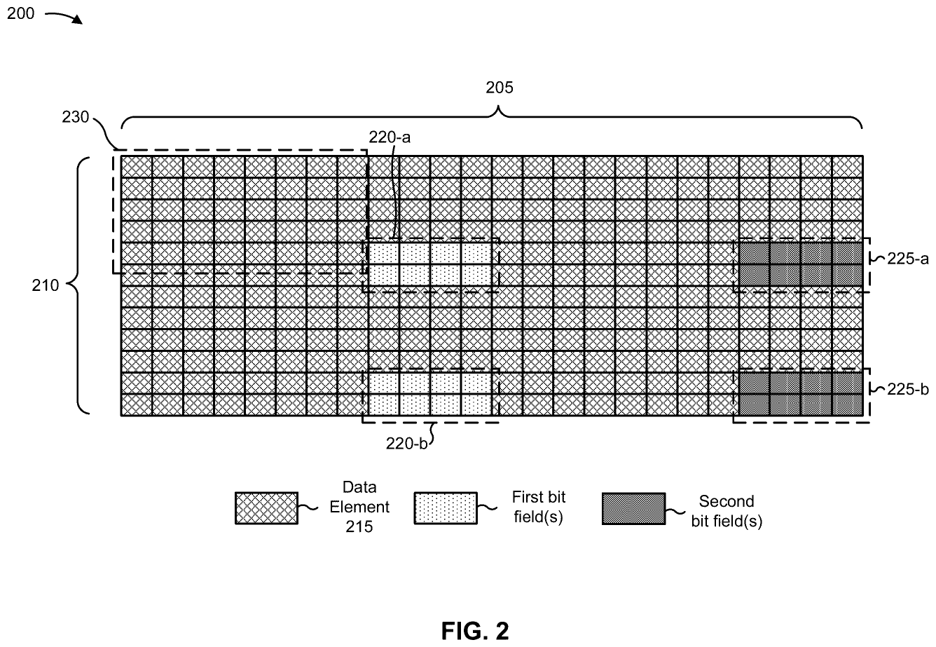

FIG. 2 shows an example of a data packet 200 that supports signaling for various memory features. The data packet 200 may illustrate a format of signaling communicated between a host system (e.g., the host system 105) and a memory system (e.g., the memory system 110) specified by a communication protocol, such as a low-power double data rate (LPDDR) protocol. The data packet 200 is provided as an example. The techniques and aspects described herein may be similarly applied for other technologies or communication protocols (e.g., other than the LPDDR protocol), in which case a data packet having a different format or configuration may be used in a similar manner as described herein.

The data packet 200 may include one or more elements arranged according to one or more time intervals 205, which may be referred to as “beats”, and one or more pins 210 of a bus (e.g., the host interface 140) between the host system and the memory system. Each pin 210 of bus may communicate a single element between the host system and the memory system during each time interval 205. An element corresponding to a given time interval 205 and a given pin 210 may represent a voltage level of the given pin 210 during the given time interval 205. For example, an element may be a single bit, such as a high state (e.g., a logic “1”) or a low state (e.g., a logic “0”) at an edge (e.g., a rising edge, a falling edge) of a clock signal used as part of binary signaling. Additionally, or alternatively, an element may correspond to a voltage level of other signaling schemes, such as non-return-to-zero (NRZ) signaling, three-level pulse-amplitude modulation (PAM-3) signaling, and/or PAM-4 signaling, among other examples.

The one or more elements may include one or more data elements 215. The one or more data elements 215 of the data packet may represent the payload of the data packet 200, such as user data communicated between the host system and the memory system.

In some examples, the communication protocol may specify one or more locations (e.g., one or more subsets of the time intervals 205 and/or the pins 210, one or more portions of the data packet 200) within the data packet 200 to include control information associated with the payload of the data packet 200. As shown in FIG. 2, the one or more locations may include a first location 220 (e.g., a first one or more bit fields) and a second location 225 (e.g., a second one or more bit fields). As used herein, “bit field” refers to a segment of bits allocated to represent particular information or control signals within a data packet, such as the data packet 200. For example, the communication protocol may specify that system metadata may be included at a location 220-a and/or a location 220-b, as shown in FIG. 2. For example, the communication protocol may provision the location 220 for system metadata. The memory system may store information in the locations 220 to one or more memory arrays provisioned for system metadata.

In some examples, the host system and/or the memory system may use the location 225 to communicate an inversion configuration (e.g., a DBI operation). For example, the inversion configuration may include one or more inversion elements (e.g. one or more DBI bits). Each inversion element may correspond to a respective portion 230 of the data elements 215 and may indicate whether the data elements 215 of the respective portion 230 are to be inverted. For example, the data elements 215 may be partitioned into respective portions 230 (e.g., one portion 230 is shown in FIG. 2 as an example). A portion 230 may also be referred to herein as a DBI data block, or a data block. Inverting a data element 215 may include changing the state of the data element 215. For example, if a data element 215 includes a logic “1”, then inverting the data element 215 may include changing the data element 215 to include a logic “0”. Alternatively, if a data element 215 includes a logic “0”, then inverting the data element 215 may include changing the data element 215 to include a logic “1”.

By way of example, if a given inversion element (e.g., a given DBI bit) corresponding to a given portion 230 of the data elements 215 is a first value (e.g., a logic “1”), then encoding the data packet 200 may include inverting each data element 215 of the portion. Alternatively, if the inversion element is a second value (e.g., a logic “0”), then encoding the data packet 200 may include refraining from inverting each data element 215 of the portion 230. The host system and/or the memory system may determine the inversion configuration to mitigate power consumption and/or signal interference, such as by mitigating the quantity of logical “1s” in the data packet 200 (which may reduce power consumption) and/or by mitigating variance in the data packet 200, such as by reducing the quantity of transitions between a high signal state and a low signal state of a pin 210. In some implementations, the inversion configuration may be dynamically determined based on real-time assessment of the payload of the data packet 200 and/or performance of the one or more pins 210.

In some cases, the host system may include one or more additional system metadata elements in the location 220 or the location 225. For example, the host system may include additional parity information or other system metadata to improve the reliability of the data packet 200. To allow for such additional system metadata elements, the host system may reduce the quantity of inversion elements of the inversion configuration. In such examples, the host system may adjust the size (e.g., quantity of elements) and/or arrangement of the portions 230 in accordance with the quantity of inversion elements (e.g., the quantity of DBI bits). By way of example, if a first inversion configuration includes twice as many inversion elements (e.g., twice as many DBI bits) compared to a second inversion configuration, then portions 230 corresponding to the first inversion configuration may be half the size of portions 230 corresponding to the second inversion configuration.

In some examples, the communication protocol may specify that location 225 can be used for one memory operation or feature from a set of memory operations or features. As an example, the set of memory operations may include an inversion operation (e.g., a DBI operation) and a link protection operation (e.g., a link ECC operation). For example, the communication protocol may define that the set of memory operations or features are exclusive functions. In other words, if the host system configures a memory operation or feature (e.g., from the set of memory operations or features) as being enabled, then the remaining operations or functions from the set of memory operations or features are disabled. As an example, a given data packet 200 may include inversion elements (e.g., DBI elements) or parity information (e.g., for a link ECC operation) in the location 225, but not both.

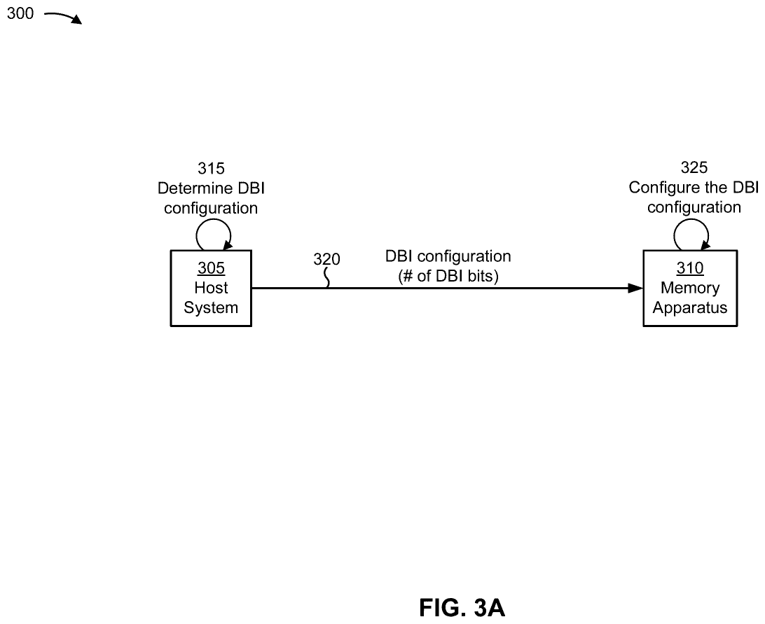

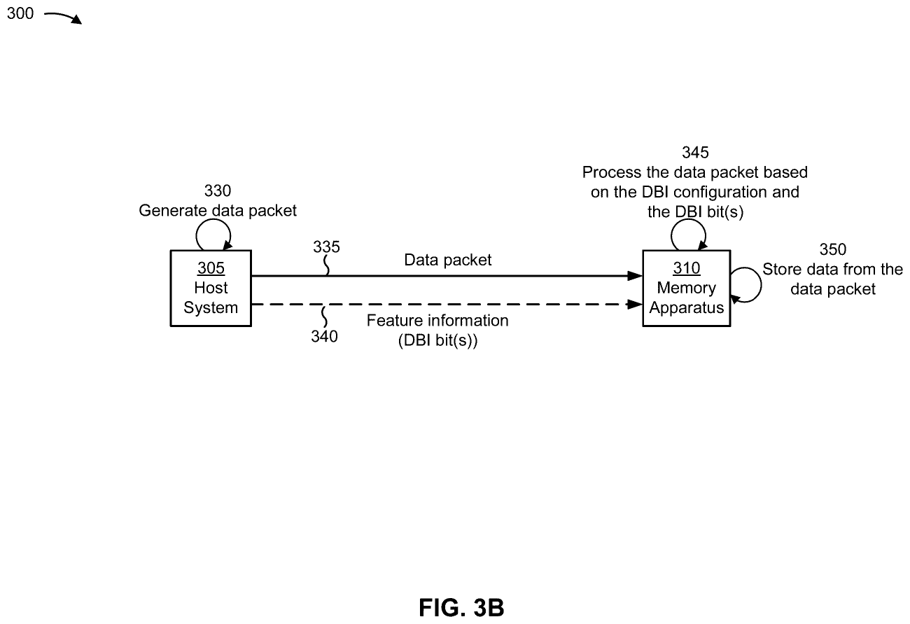

As described in more detail elsewhere herein (such as in connection with FIGS. 3A, 3B, and 4-6), the host system may provide the memory system with a configuration that indicates a configurable amount of information (e.g., a configurable quantity of bits) to be communicated via the location 225 (e.g., the location 225-a and/or the location 225-b) for a given memory operation or feature. For example, for a memory operation or feature that has flexibility in the quantity of bits used for each memory access, the host system can configure (or program) the amount of information (e.g., the quantity of bits) to be provided to the memory system (e.g., in the location 225 or in parallel via a multi-functional pin). As an example, the host system can configure the quantity of inversion elements (e.g., the quantity of DBI bits) to be provided to the memory system.

As indicated above, FIG. 2 is provided as an example. Other examples may differ from what is described with regard to FIG. 2.

FIGS. 3A-3B is a diagram of an example 300 of configurable data bus inversion operation. As shown in FIGS. 3A-3B, a host system 305 (e.g., the host system 105) may communicate with a memory apparatus 310. The memory apparatus 310 may be the memory system 110 or a memory device 120. The operations described in connection with the memory apparatus 310 may be performed by the memory system 110 and/or one or more components of the memory system 110, such as the memory system controller 115, one or more memory devices 120, and/or one or more local controllers 125. The host system 305 and the memory apparatus 310 may communicate via an interface, such as the host interface 140.

As shown in FIG. 3A, and by reference number 315, the host system 305 may determine a DBI configuration. The DBI configuration may indicate a quantity of DBI bits (e.g., a quantity of inversion elements) to be used for a DBI operation. For example, the DBI configuration may indicate that the host system 305 will provide one or more DBI bits to the memory apparatus 310 for the DBI operation, where the one or more DBI bits have the quantity of DBI bits indicated by the DBI configuration (e.g., if the DBI configuration indicates that the DBI operation is to use M DBI bits, then the host system 305 will provide M DBI bits to the memory apparatus 310 for the DBI operation). The DBI operation is used herein as an example of an operation for which the quantity of bits (e.g., the amount of information) provided to the memory apparatus 310 is flexible. It should be understood that the host system 305 may configure an amount of information (e.g., a quantity of bits) for other operations or functions in a similar manner as described herein.

The host system 305 may determine the DBI configuration based on one or more factors, such as the requirements of an application executing on the host system 305, a desired (or user configured) balance between power consumption and signal integrity, a user configuration or preferences, and/or overall system performance goals, among other examples. For example, in high-speed memory environments where minimizing power consumption and reducing noise are dominant factors for performance, the host system 305 may configure (or program) a higher quantity of DBI bits to achieve greater inversion coverage. As another example, in scenarios where other memory features, such as error correction or security features, are prioritized, the host system 305 may configure a lower quantity of DBI bits to allocate more bits for those functions (e.g., improving link ECC diagnostic coverage). This flexibility allows the host system 305 to dynamically adjust the DBI configuration to optimize the performance and reliability of the memory apparatus 310 based on real-time operational conditions and/or use-case requirements, among other examples.

As shown by reference number 320, the host system 305 may transmit or provide, and the memory apparatus 310 may receive or obtain, the DBI configuration. The DBI configuration may be transmitted via a dedicated control interface or a configuration bus that facilitates communication between the host system 305 and the memory apparatus 310. This interface may be a high-speed serial interface or a parallel interface. In some examples, the interface may be the host interface 140.

The DBI configuration may be provided through one or more pins designated for configuration and control signals. For example, the host system 305 may use one or more control pins to transmit the DBI configuration to the memory apparatus 310. These control pin(s) may include a configuration pin (CFG) for sending configuration data. Additionally, the host system 305 may utilize multi-functional pins that can be dynamically assigned to different functions, including the transmission of DBI configuration data. These multi-functional pins offer flexibility in pin usage, allowing the system to optimize pin allocation based on current operational needs. By the host system 305 using these interfaces and pins, the host system 305 ensures that the memory apparatus 310 receives the DBI configuration to perform the DBI operation effectively.

The host system 305 may update or change the DBI configuration over time. For example, the host system 305 may program or configure the DBI operation to use a different quantity of DBI bits over time. The host system 305 may update or change the DBI configuration based on changes requirements of an application executing on the host system 305, a desired (or user configured) balance between power consumption and signal integrity, a user configuration or preferences, and/or overall system performance goals, among other examples.

As shown by reference number 325, the memory apparatus 310 may configure the DBI configuration. For example, the memory apparatus 310 may configure a DBI data block size (e.g., a size of a portion 230) based on the quantity of DBI bits indicated by the DBI configuration. For example, the memory apparatus 310 may set up internal registers and control logic within the memory apparatus 310 to recognize and process the quantity of DBI bits indicated by the DBI configuration. The memory apparatus 310 may adjust one or more data handling algorithms to accommodate the DBI data block size, ensuring that each data block is correctly inverted or not inverted based on the corresponding DBI bit. This configuration allows the memory apparatus 310 to dynamically adapt to different DBI configurations, optimizing power consumption and signal integrity based on the information indicated by the DBI configuration.

Additionally, the memory apparatus 310 may configure one or more other memory operations or features based on the DBI configuration. For example, the DBI operation may share a bit field (e.g., the location 225) in a data block format with the one or more other memory operations or features. As another example, the DBI operation may be associated with a multi-functional pin that is associated with the one or more other memory operations or features. The memory apparatus 310 may determine an amount of information (e.g., a quantity of bits) that will be provided by the host system 305 for the one or more other memory operations or features based on the DBI configuration. For example, based on a size of a bit field (or a quantity of bits transmitted over a period of time via the multi-functional pin) and the quantity of DBI bits indicated by the DBI configuration, the memory apparatus 310 may determine the amount of information (e.g., a quantity of bits) that will be provided by the host system 305 for the one or more other memory operations or features (e.g., if a bit field has a size of L bits and the DBI configuration indicates M DBI bits will be provided, then the memory apparatus may determine that the quantity of bits allocated for the one or more other memory operations or features is (L−M)). The one or more other memory operations or features may include a parity function (e.g., a link parity operation), an ECC function, an EDC function, a cyclic redundancy check (CRC) function, among other examples.

To configure these other memory features, the memory apparatus 310 may allocate the remaining bits in the bit field or the multi-functional pin to the respective functions. For example, if the DBI configuration uses 4 out of 16 available bits, the remaining 12 bits could be allocated to an ECC function. The memory apparatus 310 may then set up control logic to process these ECC bits, ensuring error detection and correction are performed as required. Similarly, if the DBI configuration indicates a different allocation, the memory apparatus 310 may dynamically adjust the bit allocation and configure the corresponding memory features accordingly. This flexibility allows the memory apparatus 310 to efficiently manage multiple memory operations, optimizing overall system performance and reliability based on the current DBI configuration.

As shown in FIG. 3B, and by reference number 330, the host system 305 may generate a data packet. The host system 305 may obtain data to be included in the data packet from one or more sources, such as host memory, a peripheral device, and/or data received from external networks, among other examples. This data may include mission-critical information, user data, control signals, and/or other relevant information for the operation of the memory apparatus 310. The host system 305 may aggregate this data, ensuring that the data is formatted correctly and ready for transmission to the memory apparatus 310.

Once the data is collected, the host system 305 may encode the data using a DBI operation based on the quantity of DBI bits indicated by the DBI configuration. The DBI operation involves analyzing the data to determine the number of ‘1’ bits in each DBI data block. If the number of ‘1’ bits satisfies a DBI threshold (e.g., more than half of the bits in the block), then the host system 305 inverts the data block, changing all ‘1’ bits to ‘0’ bits and vice versa. This inversion helps to reduce power consumption and improve signal integrity by minimizing the number of transitions between ‘1’ and ‘0’ states. The host system 305 then generates one or more DBI bits to indicate whether each corresponding DBI data block has been inverted. In some examples, the one or more DBI bits are included in the data packet alongside the encoded data blocks. In other examples, the one or more DBI bits may be provided in parallel to the data packet (e.g., via a multi-functional pin).

The host system 305 may prepare the data packet for transmission to the memory apparatus 310. The host system 305 may ensure that the data packet is in accordance with one or more communication protocols and/or timing specifications, facilitating efficient and reliable communication with the memory apparatus 310. By encoding the data using the DBI operation and including the necessary DBI bits, the host system 305 optimizes the data transmission process, enhancing the overall performance and reliability of the memory system.

In some aspects, the host system 305 may generate feature information for the data packet. The feature information may include the one or more DBI bits. Additionally, or alternatively, the feature information may include information for other memory operations or features. For example, the feature information may include parity information, ECC information, EDC information, and/or CRC information, among other examples. [expand on the type of information that could be included in the feature information.

The feature information may enable the memory apparatus 310 to ensure the integrity, reliability, and/or security of the data being transmitted. For example, parity information may include one or more parity bits that allow the memory apparatus 310 to detect errors in the transmitted data by checking whether the number of ‘1’ bits is odd or even. ECC information may include additional bits that enable the memory apparatus 310 to not only detect but also correct certain types of errors within the data packet, thereby enhancing data reliability. EDC information may provide mechanisms for identifying errors in the data transmission, ensuring that any corrupted data is flagged for retransmission or correction. CRC information may include a checksum value calculated from the data, which the memory apparatus 310 can use to verify the integrity of the received data packet. This enables the memory apparatus 310 to detect any alterations or corruption that may have occurred during transmission.

In some examples, the feature information may include metadata related to security functions, such as encryption keys or authentication codes, which ensure that the data is protected against unauthorized access and tampering. Additionally, the feature information may include system-specific information, such as address information or configuration settings.

A size of the feature information may be based on the DBI configuration. For example, a quantity of bits allocated for the feature information may be based on the quantity of DBI bits indicated by the DBI configuration. The relationship between the size of the feature information and the quantity of DBI bits enables optimization of the use of available bit fields within the data packet or the use of a multi-functional pin.

For example, when the DBI configuration specifies a higher quantity of DBI bits, the size of the feature information allocated for other memory operations or features may be reduced accordingly. For example, if the DBI configuration indicates that 8 DBI bits are to be used, and the total bit field available for feature information is 32 bits, then 24 bits remain for other functions, such as ECC, EDC, parity, or CRC. Conversely, if the DBI configuration specifies only 4 DBI bits, then 28 bits can be allocated for the other memory features, allowing for more extensive error correction or additional metadata.

This dynamic allocation ensures that the memory apparatus 310 can flexibly balance the need for DBI coverage with other memory operations or features. For example, in scenarios where signal integrity and power consumption are prioritized, more DBI bits may be allocated, reducing the bits available for error correction but still maintaining an acceptable level of data reliability. In another example, in environments where data integrity is prioritized, fewer DBI bits may be used, allowing more bits to be dedicated to robust error correction schemes.

As shown by reference number 335, the host system 305 may transmit or provide, and the memory apparatus 310 may obtain or receive, the data packet. For example, the host system 305 may transmit or provide, and the memory apparatus 310 may obtain or receive, the data packet via one or more DQ pins in an interface (e.g., the host interface 140).

In some examples, as shown by reference number 340, the host system 305 may transmit or provide, and the memory apparatus 310 may receive or obtain, the feature information. The feature information may include the one or more DBI bits (e.g., of a quantity equal to the quantity of DBI bits indicated by the DBI configuration). Additionally, the feature information may include information for one or more other memory operations or features, such as parity information, link ECC information, EDC information, CRC information, and/or system metadata, among other examples.

In some aspects, the host system 305 may transmit or provide, and the memory apparatus 310 may receive or obtain, the feature information in serial relative to the data packet. In such examples, the feature information may be included in the data packet. For example, the feature information may be included in one or more locations (e.g., one or more bit fields) within the data packet. In such examples, the host system 305 may transmit or provide, and the memory apparatus 310 may receive or obtain, the feature information via the same one or more pins (e.g., one or more DQ pins) used to transport the data packet. This may reduce the quantity of pins used to provide the feature information to the memory apparatus 310. The serial transport of the feature information is depicted and described in more detail in connection with FIG. 4.

In some other aspects the host system 305 may transmit or provide, and the memory apparatus 310 may receive or obtain, the feature information in parallel relative to the data packet. In such examples, the host system 305 may transmit or provide, and the memory apparatus 310 may receive or obtain, the data packet via one or more first pins (e.g., one or more DQ pins). The host system 305 may transmit or provide, and the memory apparatus 310 may receive or obtain, the feature information via one or more second pins (e.g., that are different that the one or more first pins). The one or more second pins may be multi-functional pins. The parallel transport method enables more data or information for other memory operations or features to be included in the data packet (e.g., because the feature information is not included in the data packet). The parallel transport method is depicted and described in more detail in connection with FIG. 5.

As shown by reference number 345, the memory apparatus 310 may process the data packet based on the DBI configuration and the one or more DBI bits (e.g., received via the feature information). For example, the memory apparatus 310 may identify one or more DBI data blocks (e.g., portions 230) in the data packet based on the DBI configuration (e.g., a size of each DBI data block is based on the quantity of DBI bits indicated by the DBI configuration). For each DBI data block, the memory apparatus 310 may identify a DBI bit (e.g., from the feature information) corresponding to that DBI data block.

For example, the memory apparatus 310 may decode data in a given DBI data block based on the value of a DBI bit corresponding to the given DBI data block. If the DBI bit indicates that the data block has been inverted (e.g., the DBI bit is set to a value of ‘1’), then the memory apparatus 310 inverts the data bits in the DBI data block (e.g., changing ‘1’s to ‘0’s and vice versa) to restore the original data. If the DBI bit indicates that the data block has not been inverted (e.g., the DBI bit is set to a value of ‘0’), then the memory apparatus 310 processes the data block as is without any inversion.

In some implementations, in addition to processing DBI, the memory apparatus 310 may perform other memory operations or features using other feature information. For example, the memory apparatus 310 may perform a parity operation by generating or checking parity bits (e.g., indicated by the feature information) to ensure data integrity. The memory apparatus 310 may perform a link ECC operation to correct any errors in the data packet using an ECC (e.g., using ECC information indicated by the feature information). As another example, the memory apparatus 310 may perform an EDC operation to detect errors in the data transmission, and/or and a CRC operation to verify the accuracy of the data packet. These additional memory operations or features may enhance the reliability and integrity of the data processed by the memory apparatus 310 from the data packet.

As shown by reference number 350, the memory apparatus 310 may store (or write) data from the data packet to memory. For example, the memory apparatus 310 may processes the data packet to decode any DBI data blocks as described above, ensuring that any inverted data is correctly restored. After the data is decoded, the memory apparatus 310 may identify one or more memory locations for storing the data. For example, the memory apparatus 310 may write the decoded data to one or more memory cells indicated by the one or more memory locations.

As indicated above, FIGS. 3A-3B are provided as an example. Other examples may differ from what is described with regard to FIGS. 3A-3B.

FIG. 4 is a diagram of an example 400 of a serial transport mechanism for a configurable data bus inversion operation. The operations described in connection with FIG. 4 may be performed by the memory apparatus 310, the memory system 110 and/or one or more components of the memory system 110, such as the memory system controller 115, one or more memory devices 120, and/or one or more local controllers 125. Additionally, or alternatively, the operations described in connection with FIG. 4 may be performed by the host system 305, the host system 105, and/or the host processor 150.

As shown in FIG. 4, a DBI configuration 405 may indicate a quantity of DBI bits 420 to be provided as part of a DBI operation for data packets transmitted between the host system 305 and the memory apparatus 310, in a similar manner as described in connection with reference number 315 and reference number 320. As an example, in a first configuration option (e.g., option 1), the DBI configuration 405 may indicate that two DBI bits 420 are to be used for the DBI operation. The first configuration option may allocate fourteen bits for one or more other memory operations or features, as shown in FIG. 4 (e.g., assuming a size of the bit field associated with the DBI operation and the one or more other memory operations or features is sixteen bits). In a second configuration option (e.g., option 2), the DBI configuration 405 may indicate that four DBI bits 420 are to be used for the DBI operation. The second configuration option may allocate twelve bits for the one or more other memory operations or features, as shown in FIG. 4. The first configuration option and the second configuration option are provided as examples and other configuration options are possible, such as a configuration options with eight DBI bits and eight bits for the one or more other memory operations or features.

In some examples, other feature bits 425 (e.g., the bits allocated for the one or more other memory operations or features) may be associated with a single memory operation or feature, such as a link ECC operation, among other examples. In other examples, the other feature bits (e.g., the bits allocated for the one or more other memory operations or features) may be associated with multiple memory operations or features.

As shown in FIG. 4, a data packet 410 may be provided in accordance with the first configuration option. The data packet 410 may be an example of the data packet provided by the host system 305 as described in connection with reference number 335. The data packet 410 may have a similar format as the data packet 200 described in connection with FIG. 2. For example, the data packet 410 may include one or more first locations (e.g., locations 220 or bit fields) in which system metadata is included. Additionally, the data packet 410 may include one or more second locations (e.g., locations 225 or bit field(s)) that are shared or used to provide information for multiple memory operations or features (e.g., including the DBI operation). As shown in FIG. 4, the data packet 410 may include two DBI bits 420 (e.g., a first DBI bit 420a and a second DBI bit 420b). Because the first configuration option indicates that the quantity of DBI bits is two, the data packet 410 may be partitioned or grouped into two DBI data blocks (e.g., two portions 230). The first DBI bit 420a may correspond to a first DBI data block (e.g., DBI data block 1 as shown in FIG. 4) and the second DBI bit 420b may correspond to a second DBI data block (e.g., DBI data block 2 as shown in FIG. 4). For example, the value of the first DBI bit 420a may indicate whether the data (e.g., data elements 215) included in the first DBI data block are to be inverted, as described in more detail elsewhere herein. The second DBI bit 420b may indicate whether the data (e.g., data elements 215) included in the second DBI data block are to be inverted, as described in more detail elsewhere herein.

The data packet 410 may include information for the one or more other memory operations or features (e.g., may include the other feature bits 425). For example, the data packet 410 may include the other feature bits 425 in the same location or bit field(s) (e.g., the locations 225) as the DBI bits 420. As shown in FIG. 4, a size of the information for the one or more other memory operations or features (e.g., the quantity of the other feature bits 425) may be based on the quantity of DBI bits 420 and the size of the location or bit field(s) (e.g., the locations 225). For example, the location or bit field(s) (e.g., the locations 225) in the data packet 410 may include a set of bits. A subset of bits, from the set of bits, may be configured, programmed, or allocated for the DBI operation (e.g., the subset of bits may include the DBI bits 420). In some examples, the subset of bits may include all bits from the set of bits. Remaining bits, from the set of bits, may be configured, programmed, or allocated for the one or more other memory operations or features (e.g., for the other feature bits 425). In the example shown in FIG. 4, the size of the location or bit field(s) is sixteen bits and the quantity of DBI bits 420 is two, resulting in fourteen other feature bits 425 being included in the data packet 410.

As shown in FIG. 4, a data packet 415 may be provided in accordance with the second configuration option. The data packet 415 may be an example of the data packet provided by the host system 305 as described in connection with reference number 335. The data packet 415 may have a similar format as the data packet 200 described in connection with FIG. 2. For example, the data packet 415 may include one or more first locations (e.g., locations 220 or bit fields) in which system metadata is included. Additionally, the data packet 415 may include one or more second locations (e.g., locations 225 or bit field(s)) that are shared or used to provide information for multiple memory operations or features (e.g., including the DBI operation). As shown in FIG. 4, the data packet 415 may include four DBI bits 420 (e.g., the first DBI bit 420a, the second DBI bit 420b, a third DBI bit 420c, and a fourth DBI bit 420d). Because the second configuration option indicates that the quantity of DBI bits is four, the data packet 410 may be partitioned or grouped into four DBI data blocks (e.g., four portions 230). The first DBI bit 420a may correspond to the first DBI data block (e.g., DBI data block 1 as shown in FIG. 4), the second DBI bit 420b may correspond to the second DBI data block (e.g., DBI data block 2 as shown in FIG. 4), the third DBI bit 420c may correspond to the third DBI data block (e.g., DBI data block 3 as shown in FIG. 4), and the fourth DBI bit 420dfo may correspond to the fourth DBI data block (e.g., DBI data block 4 as shown in FIG. 4).

For example, the value of the first DBI bit 420a may indicate whether the data (e.g., data elements 215) included in the first DBI data block are to be inverted, as described in more detail elsewhere herein. The second DBI bit 420b may indicate whether the data (e.g., data elements 215) included in the second DBI data block are to be inverted. The third DBI bit 420c may indicate whether the data (e.g., data elements 215) included in the third DBI data block are to be inverted. Similarly, the fourth DBI bit 420d may indicate whether the data (e.g., data elements 215) included in the fourth DBI data block are to be inverted.

The data packet 415 may include information for the one or more other memory operations or features (e.g., may include the other feature bits 425). For example, the data packet 415 may include the other feature bits 425 in the same location or bit field(s) (e.g., the locations 225) as the DBI bits 420. As shown in FIG. 4, a size of the information for the one or more other memory operations or features (e.g., the quantity of the other feature bits 425) may be based on the quantity of DBI bits 420 and the size of the location or bit field(s) (e.g., the locations 225). In the example shown in FIG. 4, the size of the location or bit field(s) is sixteen bits and the quantity of DBI bits 420 is four, resulting in twelve other feature bits 425 being included in the data packet 410.

As shown in FIG. 4, the different configuration options for the DBI configuration 405 may provide a balance between a size of the DBI data blocks and an amount of information provided for the one or more other memory operations or features. As an example, a smaller DBI data block size may enable improved signal integrity. By using a smaller size of DBI data block (e.g., by the host system 305 configuring a larger quantity of DBI bits 420 in the DBI configuration 405), the memory apparatus 310 can more effectively limit the quantity of transitions between ‘1’s and ‘0’s within each DBI data block. This reduction in transitions minimizes simultaneous switching noise, which may be a source of signal degradation in data transfers. As a result, smaller DBI data blocks help maintain cleaner signal lines, leading to more reliable data transmission and reduced error rates.

Additionally, increasing the amount of information provided for the one or more other memory operations or features (e.g., increasing the quantity of other feature bits 425) may improve performance for the one or more other memory operations or features. As an example, for a link ECC operation or an EDC operation, increasing the quantity of other feature bits 425 may enable the memory apparatus 310 to increase diagnostic coverage. The increased diagnostic coverage enables the memory apparatus 310 to detect and correct a greater quantity of errors within the data packet (e.g., the data packet 410 or the data packet 415), thereby improving the overall reliability and integrity of the data. Further, with more other feature bits 425 allocated to these operations or functions, the memory apparatus 310 can implement more sophisticated error correction algorithms, which can handle more complex error patterns and provide stronger protection against data corruption.

Therefore, the host system 305 may select a configuration operation to balance the benefits between decreasing the DBI data block size and increasing the amount of information provided for the one or more other memory operations or features. For example, the host system 305 may analyze the specific requirements of the application or workload being executed. This analysis may involve assessing factors such as the expected data traffic patterns, the criticality of signal integrity, the power consumption constraints, and the necessity for robust error correction. In some examples, the host system 305 may use performance monitoring tools to gather real-time data on the operation of the memory apparatus 310, such as error rates, power usage, and/or data throughput. Based on this data, the host system 305 can determine the optimal trade-off between DBI data block size and the quantity of other feature bits 425. For example, if the system is experiencing high error rates or requires stringent data integrity, the host system 305 may opt to allocate more bits to error correction functions (such as link ECC or EDC), at the cost of using larger DBI data blocks. Conversely, if power efficiency and signal integrity are prioritized, the host system 305 may determine a configuration option with a larger quantity of DBI bits 420 to decrease the DBI data block size to minimize transitions and reduce power consumption, while still maintaining an acceptable level of error correction.

As indicated above, FIG. 4 is provided as an example. Other examples may differ from what is described with regard to FIG. 4.

FIG. 5 is a diagram of an example 500 of a parallel transport mechanism for a configurable data bus inversion operation. The operations described in connection with FIG. 4 may be performed by the memory apparatus 310, the memory system 110 and/or one or more components of the memory system 110, such as the memory system controller 115, one or more memory devices 120, and/or one or more local controllers 125. Additionally, or alternatively, the operations described in connection with FIG. 4 may be performed by the host system 305, the host system 105, and/or the host processor 150.

As shown in FIG. 5, data (e.g., a data packet) may be transmitted via one or more first pins 505. For example, the data packet described in connection with reference number 335 may be transmitted via the one or more first pins 505. The one or more first pins may be DQ pins. As shown in FIG. 5, information (e.g., a bit) may be communicated via a pin a rising and/or falling edge of a clock signal.

As shown in FIG. 5, feature information (e.g., the feature information described in connection with reference number 340) may be transmitted via a second pin 510. The second pin 510 may be a multi-functional (MF) pin. The second pin 510 may be associated with the DBI operation (e.g., information, such as DBI bits, for the DBI information may be communicated via the second pin 510). As shown in FIG. 5, different DBI configurations may be associated with a different quantity of DBI bits 515 being communicated via the second pin 510 over a time window. The time window may be an amount of time during which the data (e.g., a data packet) is communicated via the one or more first pins 505.

For example, in a first configuration option (e.g., similar to the first configuration option of the DBI configuration 405), two DBI bits 515 may be communicated via the second pin 510. For example, a first DBI bit 515a (e.g., similar to the first DBI bit 420a) and a second DBI bit 515b (e.g., similar to the second DBI bit 420b) may be communicated via the second pin 510 during the time window. The two DBI bits 515 may correspond to respective DBI data blocks (e.g., from two DBI data blocks) in the data (e.g., the data packet) transmitted via the one or more first pins 505. As shown in FIG. 5, during the time window, one or more other feature bits 520 (e.g., similar to the other feature bits 425) may be communicated via the second pin 510. For example, in the first configuration option (e.g., Option 1), fourteen other feature bits 520 may be communicated during the time window via the second pin 510.

In a second configuration option (e.g., similar to the first configuration option of the DBI configuration 405), four DBI bits 515 may be communicated via the second pin 510. For example, a first DBI bit 515a (e.g., similar to the first DBI bit 420a), a second DBI bit 515b (e.g., similar to the second DBI bit 420b), a third DBI bit 515c (e.g., similar to the third DBI bit 420c), and a fourth DBI bit 515d (e.g., similar to the fourth DBI bit 420d) may be communicated via the second pin 510 during the time window. The four DBI bits 515 may correspond to respective DBI data blocks (e.g., from four DBI data blocks) in the data (e.g., the data packet) transmitted via the one or more first pins 505. As shown in FIG. 5, during the time window, one or more other feature bits 520 (e.g., similar to the other feature bits 425) may be communicated via the second pin 510. For example, in the first configuration option (e.g., Option 1), twelve other feature bits 520 may be communicated during the time window via the second pin 510.

The different configuration options for the DBI configuration enables the host system 305 to vary or configure a balance between the quantity of DBI bits (e.g., and a DBI data block size) and the amount of information provided for the one or more other memory operations or features, as described in more detail elsewhere herein. By using the second pin 510 to transmit the feature information, the feature information can be provided in parallel with the data. This enables more data (or other information) to be provided via the one or more first pins 505. FIG. 5 shows the DBI bits 515 being communicated before the other feature bits 520 (e.g., in time) via the second pin 510 as an example. It should be understood that the DBI bits 515 and the other feature bits 520 can be communicated in any order via the second pin 510.

As indicated above, FIG. 5 is provided as an example. Other examples may differ from what is described with regard to FIG. 5.

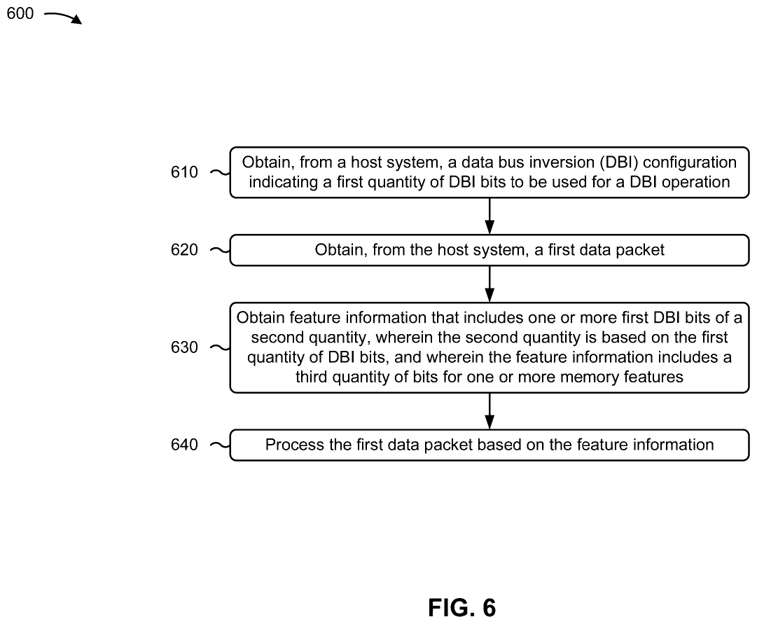

FIG. 6 is a flowchart of an example method 600 associated with configurable data bus inversion operation. In some implementations, a memory apparatus (e.g., the memory apparatus 310, the memory system 110, and/or a memory device 120) may perform or may be configured to perform the method 600. In some implementations, another device or a group of devices separate from or including the memory apparatus 310 (e.g., the system 100, the host system 105, the host processor 150, or the host system 305) may perform or may be configured to perform the method 600. Additionally, or alternatively, one or more components of the memory apparatus (e.g., the memory system controller 115 or a local controller 125) may perform or may be configured to perform the method 600. Thus, means for performing the method 600 may include the memory apparatus 310 and/or one or more components of the memory apparatus 310. Additionally, or alternatively, a non-transitory computer-readable medium may store one or more instructions that, when executed by the memory apparatus 310, cause the memory apparatus 310 to perform the method 600.

As shown in FIG. 6, the method 600 may include obtaining a DBI configuration indicating a first quantity of DBI bits to be used for a DBI operation (block 610). As further shown in FIG. 6, the method 600 may include obtaining a first data packet (block 620). As further shown in FIG. 6, the method 600 may include obtaining feature information that includes one or more first DBI bits of a second quantity, wherein the second quantity is based on the first quantity of DBI bits, and wherein the feature information includes a third quantity of bits for one or more memory features (block 630). As further shown in FIG. 6, the method 600 may include processing the first data packet based on the feature information (block 640).

The method 600 may include additional aspects, such as any single aspect or any combination of aspects described below and/or described in connection with one or more other methods or operations described elsewhere herein.

In a first aspect, the first data packet has a first size, and the first data packet is partitioned into DBI data blocks associated with respective DBI bits from the one or more first DBI bits, and the DBI data blocks have a second size that is based on the first size and the first quantity of DBI bits.

In a second aspect, alone or in combination with the first aspect, the feature information is included in the first data packet.

In a third aspect, alone or in combination with one or more of the first and second aspects, the feature information is included in a bit field of the first data packet, where the bit field includes a set of bits, where a first subset of bits, from the set of bits, are associated with the DBI operation, where the first subset of bits has the second quantity, and where a second subset of bits, from the set of bits, is associated with the one or more memory features. As an example, the first subset of bits may include the one or more DBI bits 420.

In a fourth aspect, alone or in combination with one or more of the first through third aspects, the second subset of bits has the third quantity of bits, and where the third quantity is based on a size of the bit field and the first quantity of DBI bits.

In a fifth aspect, alone or in combination with one or more of the first and fourth aspects, the one or more memory features include a parity function.

In a sixth aspect, alone or in combination with one or more of the first through fifth aspects, obtaining the first data packet includes obtaining the first data packet via a first pin, and obtaining the feature information includes obtaining the feature information via a second pin.

In a seventh aspect, alone or in combination with one or more of the first through sixth aspects, the method 600 includes obtaining, from the host system, an indication of a fourth quantity of DBI bits to be used for the DBI operation; obtaining, from the host system, a second data packet; obtaining, from the host system, one or more second DBI bits of a fifth quantity, where the fifth quantity is equal to the fourth quantity of DBI bits; and processing the second data packet based on the one or more second DBI bits.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory apparatus includes one or more components configured to: obtain, from a host system, a DBI configuration indicating a first quantity of DBI bits to be used for a DBI operation; obtain, from the host system, a data packet; obtain, from the host system, one or more DBI bits of a second quantity, wherein the second quantity is equal to the first quantity of DBI bits; and process the data packet based on the one or more DBI bits and based on the first quantity of DBI bits.

In some implementations, a method includes obtaining, by a memory apparatus and from a host system, a DBI configuration indicating a first quantity of DBI bits to be used for a DBI operation; obtaining, by the memory apparatus and from the host system, a first data packet; obtaining, by the memory apparatus from the host system, feature information that includes one or more first DBI bits of a second quantity, wherein the second quantity is based on the first quantity of DBI bits, and wherein the feature information includes a third quantity of bits for one or more memory features; and processing, by the memory apparatus, the first data packet based on the feature information.

In some implementations, a system includes a host system configured to: program a DBI configuration for a memory apparatus, wherein the DBI configuration indicates a quantity of DBI bits to be used for a DBI operation; provide, to the memory apparatus, a data packet; and provide, to the memory apparatus, one or more DBI bits for the DBI operation and for the data packet, wherein the one or more DBI bits have the quantity of DBI bits.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more components configured to:
obtain, from a host system, a data bus inversion (DBI) configuration indicating a first quantity of DBI bits to be used for a DBI operation;
obtain, from the host system, a data packet;
obtain, from the host system, one or more DBI bits of a second quantity, wherein the second quantity is equal to the first quantity of DBI bits; and
process the data packet based on the one or more DBI bits and based on the first quantity of DBI bits.

2. The memory apparatus of claim 1, wherein the data packet has a first size, and wherein the data packet is partitioned into DBI data blocks associated with respective DBI bits from the one or more DBI bits, and wherein the DBI data blocks have a second size that is based on the first size and the first quantity of DBI bits.

3. The memory apparatus of claim 2, wherein the one or more components, to process the data packet, are configured to:
process each DBI data block, from the DBI data blocks, included in the data packet based on a DBI bit, from the one or more DBI bits, associated with that DBI data block.

4. The memory apparatus of claim 1, wherein the one or more DBI bits are included in the data packet.

5. The memory apparatus of claim 4, wherein the one or more DBI bits are included in a bit field of the data packet, wherein the bit field includes a set of bits, wherein a first subset of bits, from the set of bits, are associated with the DBI operation, and wherein the first subset of bits has the second quantity.

6. The memory apparatus of claim 5, wherein a second subset of bits, from the set of bits, are associated with a memory feature, and wherein the second subset of bits has a third quantity of bits that is based on a size of the bit field and the first quantity of DBI bits.

7. The memory apparatus of claim 6, wherein the memory feature includes at least one of:
a parity feature,
an error correction code feature,
an error detection code feature, or
a cyclic redundancy check feature.

8. The memory apparatus of claim 1, wherein the one or more components, to obtain the data packet, are configured to:
obtain the data packet via a first pin; and
wherein the one or more components, to obtain the one or more DBI bits, are configured to:
obtain the one or more DBI bits via a second pin.

9. The memory apparatus of claim 8, wherein the second pin is a multi-functional pin associated with the DBI operation and one or more features, and wherein a third quantity of bits associated with the one or more features is based on the first quantity of DBI bits.

10. A method, comprising:
obtaining, by a memory apparatus and from a host system, a data bus inversion (DBI) configuration indicating a first quantity of DBI bits to be used for a DBI operation;
obtaining, by the memory apparatus and from the host system, a first data packet;
obtaining, by the memory apparatus from the host system, feature information that includes one or more first DBI bits of a second quantity, wherein the second quantity is based on the first quantity of DBI bits, and wherein the feature information includes a third quantity of bits for one or more memory features; and
processing, by the memory apparatus, the first data packet based on the feature information.

11. The method of claim 10, wherein the first data packet has a first size, and wherein the first data packet is partitioned into DBI data blocks associated with respective DBI bits from the one or more first DBI bits, and wherein the DBI data blocks have a second size that is based on the first size and the first quantity of DBI bits.

12. The method of claim 10, wherein the feature information is included in the first data packet.

13. The method of claim 12, wherein the feature information is included in a bit field of the first data packet, wherein the bit field includes a set of bits, wherein a first subset of bits, from the set of bits, are associated with the DBI operation, wherein the first subset of bits has the second quantity, and wherein a second subset of bits, from the set of bits, is associated with the one or more memory features.

14. The method of claim 13, wherein the second subset of bits has the third quantity of bits, and wherein the third quantity is based on a size of the bit field and the first quantity of DBI bits.

15. The method of claim 10, wherein the one or more memory features include a parity function.

16. The method of claim 10, wherein obtaining the first data packet comprises:
obtaining the first data packet via a first pin; and
wherein obtaining the feature information comprises:
obtaining the feature information via a second pin.

17. The method of claim 10, further comprising:
obtaining, from the host system, an indication of a fourth quantity of DBI bits to be used for the DBI operation;
obtaining, from the host system, a second data packet;
obtaining, from the host system, one or more second DBI bits of a fifth quantity, wherein the fifth quantity is equal to the fourth quantity of DBI bits; and
processing the second data packet based on the one or more second DBI bits.

18. A system, comprising:
a host system configured to:
program a data bus inversion (DBI) configuration for a memory apparatus, wherein the DBI configuration indicates a quantity of DBI bits to be used for a DBI operation;
provide, to the memory apparatus, a data packet; and
provide, to the memory apparatus, one or more DBI bits for the DBI operation and for the data packet, wherein the one or more DBI bits have the quantity of DBI bits.

19. The system of claim 18, wherein the one or more DBI bits are included in the data packet.

20. The system of claim 19, wherein the one or more DBI bits are included in a bit field of the data packet, wherein the bit field includes a set of bits, wherein a first subset of bits, from the set of bits, are associated with the DBI operation, and wherein the first subset of bits has the quantity of DBI bits.

21. The system of claim 20, wherein a second subset of bits, from the set of bits, are associated with a memory feature, and wherein the second subset of bits has a quantity of bits that is based on a size of the bit field and the quantity of DBI bits.

22. The system of claim 18, wherein the host system, to provide the data packet, is configured to:
provide the data packet via a first pin; and
wherein the host system, to provide the one or more DBI bits, is configured to:
provide the one or more DBI bits via a second pin.

23. The system of claim 22, wherein the second pin is a multi-functional pin associated with the DBI operation and one or more features, and wherein a quantity of bits associated with the one or more features is based on the quantity of DBI bits.

24. The system of claim 18, wherein the DBI configuration is a first DBI configuration, wherein the quantity of DBI bits is a first quantity of DBI bits, and wherein the host system is configured to:
program a second DBI configuration for the memory apparatus, wherein the second DBI configuration indicates a second quantity of DBI bits to be used for the DBI operation.
